(19) United States
(12) Patent Application Publication
(10) Pub. No.: US 2022/0293975 A1
(43) Pub. Date: Sep. 15, 2022

(54) SOFC WATER MANAGEMENT SYSTEM AND NEW ENERGY VEHICLE

(71) Applicant: Ceres Intellectual Property Company Limited, Horsham, West Sussex (GB)

(72) Inventors: Cuiling Song, Weifang, Shandong (CN); Yanyan Jia, Weifang, Shandong (CN)

(21) Appl. No.: 17/634,913

(22) PCT Filed: Oct. 2, 2020
(86) PCT No.: PCT/IB20/59261

§ 371 Date: Feb. 11, 2022

(30) Foreign Application Priority Data
Aug. 14, 2019 (CN) 201921321352.1

(51) Int. Cl. H01M 8/04119; C02F 1/00; H01M 8/0612

(52) U.S. Cl. CPC H01M 8/04164; C02F 1/001; H01M 8/0618; C02F 2201/005; C02F 2209/03; C02F 2209/42; H01M 2008/1293

(57) ABSTRACT

An SOFC (solid oxide fuel cell) water management system, which comprises a condensation water storage device in cooling cooperation with a tail gas discharged by an SOFC, a water storage tank for recovering condensation water from the discharged tail gas is arranged in the condensation water storage device; a water supply pipeline in communication with a reforming reaction unit of the SOFC extends from the water storage tank, a water pump and a water volume control valve for controlling the water supply flow from the water supply pipeline are provided on the water supply pipeline. The tail gas discharged from the stack in the SOFC system exchanges heat through the condensation water storage device, a condenser provided therein exchanges heat with external air or a fuel gas so as to cool the tail gas discharged by the stack. The condensed water is separated out, and the water storage tank recovers and stores the condensed water. The condensation water storage device can realize the functions of water condensation and water storage at the same time, and the water in the water storage tank is directly led out by the water pump and the water volume control valve. Thus, a water source can be obtained without external water supply. The water storage tank can provide water for the reforming reaction unit through the water supply pipeline. The water supply is convenient, and the water volume control is accurate and stable.

### TECHNICAL FIELD

The present invention relates to the technical field of new energy vehicles, and more specifically, to an SOFC water management system and a new energy vehicle.

### BACKGROUND ART

Solid Oxide Fuel Cell (SOFC) is a fuel cell that uses a solid oxide as an electrolyte and works at high temperatures.

In the case where an SOFC uses a fuel gas other than hydrogen, the fuel gas needs to be reformed before entering the stack, and this gas reforming reaction needs water. In order to ensure the progress of the reforming reaction and also ensure that the hydrocarbon ratio is within a required range, it is necessary to control the flow rate of the water supply. In the existing technology, an external water source is typically used for this water supply, and the water is controlled to reach a reaction site in a regular and quantitative manner. Thus, on the one hand, an independent water storage structure is needed; on the other hand, water needs to be replenished in a timely manner, which may increase the burden of water supply.

Therefore, how to improve the convenience of SOFC water supply becomes a problem.

### SUMMARY OF THE INVENTION

The present invention provides an SOFC water management system to improve the convenience of SOFC water supply. The present invention also provides a new energy vehicle.

A first aspect of the invention provides an SOFC water management system comprises a condensation water storage device in cooling cooperation with a tail gas discharged from an SOFC, and a water storage tank for recovering condensate water from the discharged tail gas is provided in the condensation water storage device; a water supply pipeline connected to a reforming reaction unit of the SOFC extends from the water storage tank, and a water pump and a water volume control valve are provided to the water supply pipeline for controlling water supply flow thereof.

The water storage tank can be provided with a liquid level sensor for detecting a height of a liquid level therein, and a drainage channel for draining water when the liquid level in the water storage tank exceeds a predetermined value, and the drainage channel is provided with a solenoid valve controlled through an electrical connection with the liquid level sensor.

The water supply pipeline can be further provided with a constant pressure valve that controls water supply pressure of the water pump.

The water volume control valve can be a flow switch provided at a water outlet of the water supply pipeline.

A pulsation damper for controlling pulsation of water flow in the water supply pipeline can be further provided between the water pump and the constant pressure valve.

The water supply pipeline can be further provided with a filter and a deionizer for removing particles and ions from water flow in the water supply pipeline.

A second aspect of the invention provides a new energy vehicle, which is provided with an SOFC system and a water management system for supplying water to the SOFC, characterized in that the water management system is the SOFC water management system according to the first aspect.

The present invention provides an SOFC water management system, which comprises a condensation water storage device in cooling cooperation with a tail gas discharged by an SOFC, a water storage tank for recovering condensation water from the discharged tail gas is arranged in the condensation water storage device; a water supply pipeline in communication with a reforming reaction unit of the SOFC extends from the water storage tank, a water pump and a water volume control valve for controlling the water supply flow from the water supply pipeline are provided on the water supply pipeline. The tail gas discharged from the stack in the SOFC system exchanges heat through the condensation water storage device, a condenser provided therein exchanges heat with external air or a fuel gas so as to cool the tail gas discharged by the stack. The condensed water is separated out, and the water storage tank recovers and stores the condensed water. The condensation water storage device can realize the functions of water condensation and water storage at the same time, and the water in the water storage tank is directly led out by the water pump and the water volume control valve. Thus a water source can be obtained without external water supply. The water storage tank can provide water for the reforming reaction unit through the water supply pipeline. The water supply is convenient and the water volume control is accurate and stable.

### BRIEF DESCRIPTION OF DRAWINGS

The drawings used in the description will be described briefly below. The drawings in the following description are only some embodiments of the present invention.

FIG. 1 is a block diagram of an SOFC water management system.

### DESCRIPTION OF THE EMBODIMENTS

The present invention discloses an SOFC water management system, which improves the convenience of SOFC water supply; the invention also provides a new energy vehicle.

Embodiments of the present invention will be described in conjunction with the drawings. The described embodiments are only a part rather than all of the embodiments of the present invention.

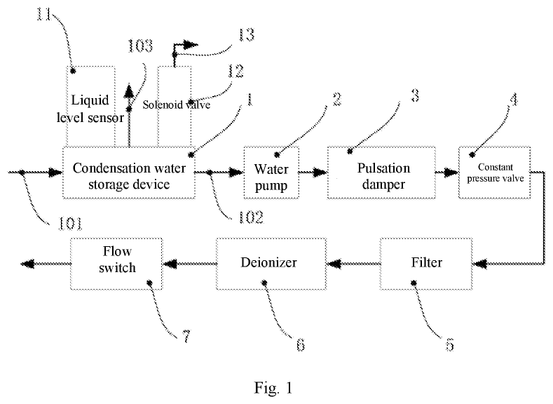

FIG. 1 is a block diagram of an SOFC water management system provided by the present invention.

The present invention provides an SOFC water management system, which comprises a condensation water storage device 1 in cooling cooperation with a tail gas 101 discharged by an SOFC, a water storage tank for recovering condensation water from the discharged tail gas 101 is arranged in the condensation water storage device 1. A water supply pipeline 102 in communication with a reforming reaction unit of the SOFC extends from the water storage tank. A water pump 2 and a water volume control valve 7 for controlling the water supply flow from the water supply pipeline 102 are provided on the water supply pipeline. The tail gas 101 discharged from the stack in the SOFC system exchanges heat through the condensation water storage device 1. A condenser provided therein exchanges heat with external air or a fuel gas so as to cool the tail gas discharged by the stack. The condensed water is separated out, the tail gas 103 following the condensation enters a following channel, and the water storage tank recovers and stores the condensed water. The condensation water storage device 1 can realize the functions of water condensation and water storage at the same time, and the water in the water storage tank is directly led out by the water pump 2 and the water volume control valve 7. Thus a water source can be obtained without external water supply (although an external supply may also be present). The water storage tank can provide water for the reforming reaction unit through the water supply pipeline 102. The water supply is convenient and the water volume control is accurate and stable.

In a specific embodiment of the present invention, the water storage tank is provided with a liquid level sensor 11 for detecting the height of its liquid level, and a drainage channel 13 for draining water when the liquid level in the water storage tank exceeds a predetermined value. The drainage channel 13 is provided with a solenoid valve 12 controlled through an electrical connection with the liquid level sensor 11. Since the recovered condensation water in the SOFC system is more than the water to be used in the reforming reaction, the liquid level sensor 11 and the solenoid valve 12 are installed on the water storage tank. An SOFC system controller controls the state of opening and closing of the solenoid valve 12 according to the signal from the liquid level sensor to perform water drainage in a timely manner so as to ensure that the liquid level in the water tank is within the specified range.

In a specific embodiment of the present invention, the water supply pipeline 102 is further provided with a constant pressure valve 4 for controlling the water supply pressure of the water pump 2. Preferably, the water volume control valve 7 is a flow switch provided at the water outlet of the water supply pipeline 102. The water pump 2 draws a certain amount of water from the water storage tank, pressurizes the water, and then delivers the water to a container for reforming reaction. The system needs to control the water flow in order to reach a proper hydrocarbon ratio.

The water pump 2, the constant pressure valve 4 and the flow switch are used in combination to jointly control the water flow. The system water flow has a wide range and needs to be accurately controlled even at a low flow rate. Due to the zero drift problem of the flow switch, it cannot always accurately feedback the flow rate when the flow rate is within the required range. Thus, a control scheme that tests the flow characteristics of the water pump and writes them into the controller may be employed to control the water flow in an open loop.

Since the flow of the water pump 2 may be affected by the pressure at the outlet of the water pump, a constant pressure valve 4 is further provided to fix the pressure at the outlet of the water pump. Accordingly, the flow of the water pump 2 and the control signal are in a one-to-one correspondence. In order to improve the safety of the system and the detection of faults, a flow switch may be further provided to detect whether there is water flow. If the actual situation does not match the demand, a signal can be sent so that the controller can make a proper judgment, such as to shut down the SOFC system according to the specific situation.

In a specific embodiment of the present invention, a pulsation damper 3 for controlling the pulsation of the water flow in the water supply pipeline may also be provided between the water pump 2 and the constant pressure valve 4. The water flow at the outlet of the water pump 2 may have a pulsation. Accordingly, the pulsation damper 3 can be used to reduce the pulsation of the flow and make the flow supply more stable.

In a specific embodiment of the present invention, the water supply pipeline 102 may also be provided with a filter 5 and a deionizer 6 for removing particles and ions from the water flow in the water supply pipeline 102. The filter 5 and the deionizer 6 can remove particles and ions from the water, so as to prevent these particles and ions from entering the stack and affecting the service life of the stack.

On the basis of the SOFC water management system provided in the above-mentioned embodiments, the present invention further provides a new energy vehicle with an SOFC system and a water management system for water supply to the SOFC. The water management system provided on the new energy vehicle is the SOFC water management system provided in the embodiments described above.

Since the new energy vehicle employs the SOFC water management system described in the foregoing embodiments, the foregoing embodiments provide the disclosed beneficial effects brought by the SOFC water management system to the new energy vehicle.

Various modifications to these embodiments will be apparent. The general principles defined herein can be implemented in other embodiments without departing from the scope of the present invention.

1. An SOFC water management system, comprising
a condensation water storage device in cooling cooperation with a tail gas discharged from an SOFC, wherein a water storage tank for recovering condensate water from the discharged tail gas is provided in the condensation water storage device; and
a water supply pipeline connected to a reforming reaction unit of the SOFC extending from the water storage tank;
wherein a water pump and a water volume control valve are provided in the water supply pipeline for controlling water supply flow thereof.

2. The SOFC water management system according to claim 1, characterized in that the water storage tank is provided with a liquid level sensor for detecting a height of a liquid level therein, and a drainage channel for draining water when the liquid level in the water storage tank exceeds a predetermined value, wherein the drainage channel is provided with a solenoid valve controlled through an electrical connection with the liquid level sensor.

3. The SOFC water management system according to claim 2, characterized in that the water supply pipeline is further provided with a constant pressure valve that controls water supply pressure of the water pump.

4. The SOFC water management system according to claim 3, characterized in that the water volume control valve is a flow switch provided at a water outlet of the water supply pipeline.

5. The SOFC water management system according to claim 3, characterized in that a pulsation damper for controlling pulsation of water flow in the water supply pipeline is further provided between the water pump and the constant pressure valve.

6. The SOFC water management system according to claim 1, characterized in that the water supply pipeline is further provided with a filter and a deionizer for removing particles and ions from water flow in the water supply pipeline.

7. A new energy vehicle, which is provided with an SOFC system and a water management system for supplying water to the SOFC, characterized in that the water management system is the SOFC water management system according to claim 1.

8. A new energy vehicle according to claim 7, further comprising an external water supply.
